(19) United States
(12) Patent Application Publication
(10) Pub. No.: US 2003/0135955 A1
(43) Pub. Date: Jul. 24, 2003

(54) Telescoping extension pole with built-in tube end protection

(76) Inventor: Michael J. Dove, Mission Viejo, CA (US)

Correspondence Address: Michael J. Dove, 24115 Lindley Street, Mission Viejo, CA, 92691, US

(21) Appl. No.: 10/053,292

(22) Filed: Jan. 23, 2002

(51) Int. Cl. E05B 1/00

(52) U.S. Cl. 16/429

(57) ABSTRACT

An extension pole assembly whereby individual tubes, separate and exactly the same as one another, may be joined to achieve desired length, and a locking push button connects each together as each tube end is inserted into the inside of each additional tube beginning, to form an inner and outer tube connection. The locking push button is positioned into the end of the first pole and as each additional pole is added, the added pole slips onto the first pole, the second pole forming the outer tube, the first pole forming the inner tube, the push button retains the newly connected tube into a locked position. The end of each pole contains a rubber protective insert. As each additional tube extension is added, the rubber insert is always at the end of the tube. The rubber insert provides a protective end so as not to mar or damage surroundings in work area.

### DESCRIPTION

### BACKGROUND OF THE INVENTION

1. Field of the Invention

The present invention relates to telescoping extension poles which are separate and exactly the same as each other, and, more particularly, as each extension pole is added, a protective end is always present. The invention is particularly suitable for use when working indoors or in environments where surroundings can be damaged by the blunt end of an extension pole. The rubber end minimizes such damage.

Additionally, the rubber end prevents debris from entering and deformation to the end of the pole so that future extensions are possibly without conflict.

The present invention provides a means to reach inaccessible areas in the use of various hand tools that are conveniently available on the market. One such tool frequently necessitating extension is the common paint roller. The following U.S. patent sites the necessity for extension of paint rollers;

It is therefore desirable to provide an extension pole for a paint roller, so that normally inaccessible areas can be painted without the use of a ladder. U.S. Pat. Nos. 3,380,097, Pharris; 4,461,057, Unger; and 4,524,484, Graham pertain to such poles.

2. Related Art

Extension poles are well known in the art. In a typical device, a tube is joined to another tube by inserting the beginning of one tube into the end of the joined tube, locking into position by a push button device. Locking poles are useful, for example, for extending to reach desired lengths or heights with a desired tool, such as a paint roller.

The method for a typical pole with locking characteristics to join an additional pole, includes a reduced beginning so that it may be inserted into the engaging pole end. The connection is held similarly by a push button device. However, this particular connection eliminates the ability to provide a protective end to curtail damage to surrounding obstacles in the given work environment. Thus, for example, furniture is often damaged by the blunt end of the pole when the user moves the pole to perform required work. In this particular design, one might place a rubber end onto the end of the first pole, but as each additional pole is added, the rubber end must be removed from the first pole end and placed onto the end of the second pole. If a third pole is needed for additional length, the rubber end must be removed from the second pole end and placed onto the end of the third pole. All the while the rubber end may be misplaced and if discovery of misplacement is not recognized, the chance to damage surrounding furnishings is enhanced. In addition, the time taken to remove and replace the protective end with each extension can be exhausting, wasting time and exerting undo energy.

### SUMMARY OF THE INVENTION

The present invention comprises an extension pole assembly utilizing a locking push button to join additional poles, each pole having a protective end.

More particularly, the invention comprises an extension pole assembly comprised of an larger diameter beginning and a smaller diameter end, wherein the end of first tube can be inserted into the beginning of an additional tube, the end of the first tube forming the inner tube and each additional tube forming the outside of said connection. Each connection locks into position by a push button, each smaller diameter end having a rubber protective insert.

### BRIEF DESCRIPTION OF THE DRAWINGS

FIG. 1 is a perspective view of one embodiment of the extension pole assembly according to the present invention.

FIG. 1A is a view of the larger external diameter tube beginning.

FIG. 1B is a view of the opening which receives the locking push button mechanism.

FIG. 1C is a view of the smaller external diameter tube end.

FIG. 1D is a view of the a locking spring push button projecting from the said opening.

FIG. 1E is a view of the protective rubber insert.

FIG. 2 is a cross section view of FIG. 1

FIG. 2A shows the locking push button mechanism in place.

FIG. 2B shows the protective rubber insert in place and protruding beyond the end of the pole to buffer end of would-be blunt pole.

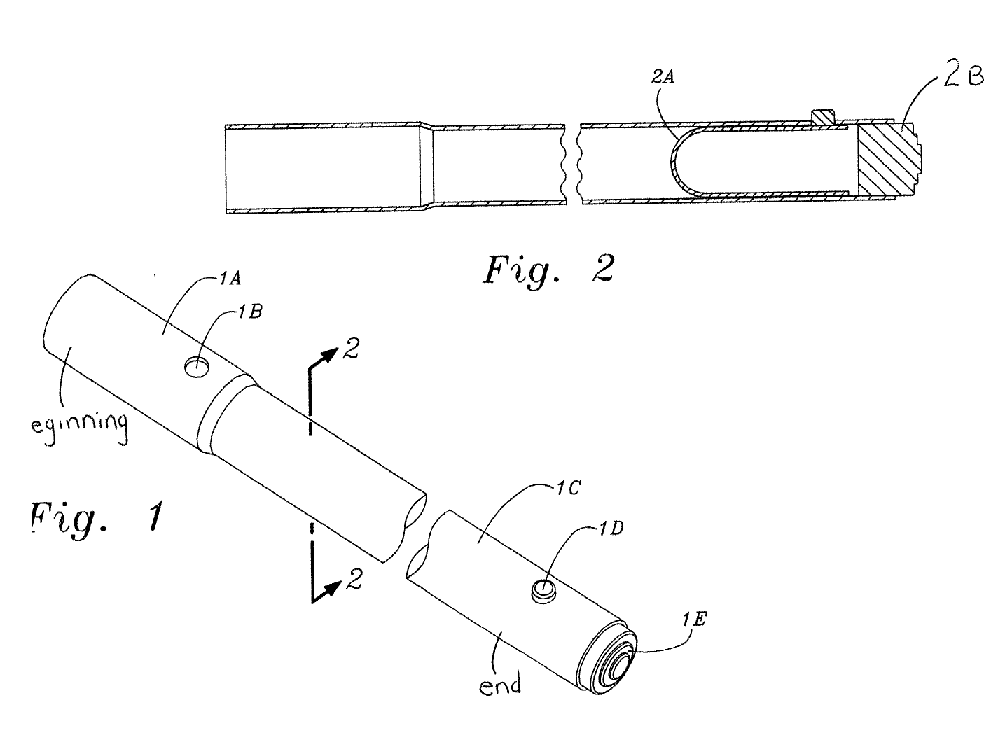

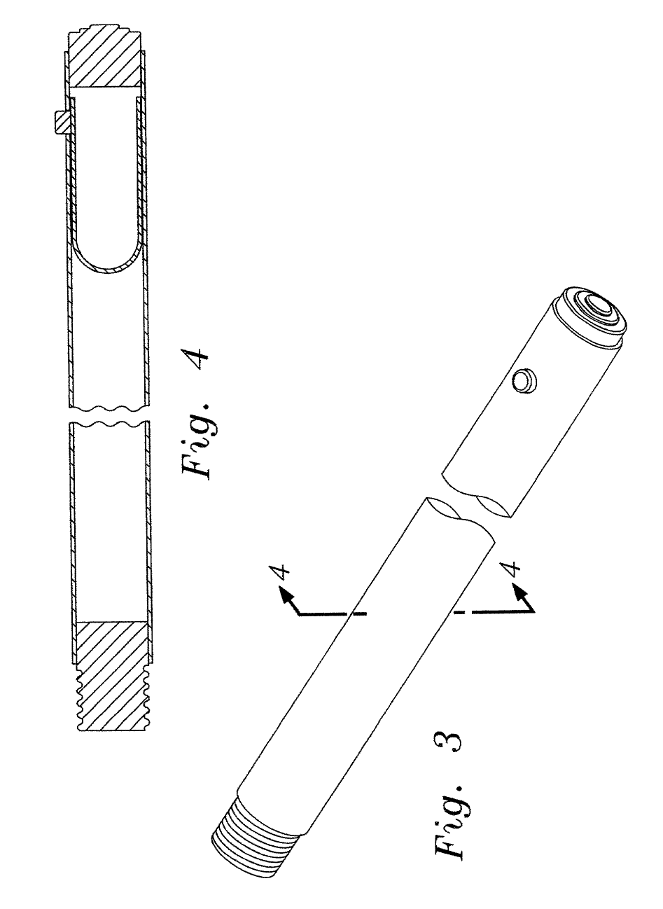

### ADDITIONAL EMBODIMENT

FIG. 3 shows a threaded connection for the connection of specialized tools or apparatus.

FIG. 4 shows a cross section view of FIG. 3

It will be understood that other modifications in the form of the invention described herein and its preferred embodiments may be made without departing from the spirit thereof and of the scope of the claims which follow.

What is claimed is:

1. An extension pole comprising:
a tube having a larger external diameter beginning;
said larger external diameter beginning having an opening in an exterior surface thereof,

2. the same tube having a smaller external diameter end;
said smaller external diameter end having an opening in an exterior surface to position a locking mechanism;
a locking mechanism comprised of,
a locking spring push button projecting from the said opening in the exterior surface;

3. the said smaller external diameter end having a rubber insert;
the said rubber insert is held in place by compression;
the said rubber insert protrudes beyond the end of the pole.
